(19) United States
(12) Patent Application Publication
(10) Pub. No.: US 2025/0279899 A1
(43) Pub. Date: Sep. 4, 2025

(54) SYSTEM AND METHOD FOR DIGITIZING AND DISSEMINATING CREDENTIALS

(71) Applicant: Christopher S. McClurg, Palatine, IL (US)

(72) Inventor: Christopher S. McClurg, Palatine, IL (US)

(21) Appl. No.: 18/945,500

(22) Filed: Nov. 12, 2024

Related U.S. Application Data
(60) Provisional application No. 63/548,214, filed on Nov. 12, 2023.

(51) Int. Cl. H04L 9/32; H04L 9/00

(52) U.S. Cl. CPC H04L 9/3263; H04L 9/3236; H04L 9/50

(57) ABSTRACT

A computer-implemented system and method are disclosed for secure and efficient digitization, validation, and dissemination of professional credentials. The system comprises a credential validation engine that integrates real-time data retrieval and cryptographic techniques to verify credential authenticity, ensuring dissemination only of active, valid credentials. By automating credential lifecycle management, the invention reduces administrative overhead and enhances data integrity, providing a significant improvement in professional networking processes. Valid credential information can be digitized, validated, and disseminated through wireless means and in digital form, issued by a credential issuer where the credential information is updated in real time and the system will display only active and valid credential information. The system can generate a first URL or URL parameter to link an image and a second URL to link content or data the badge or banner to the credential information.

### CROSS-REFERENCE TO RELATED APPLICATIONS

This application claims benefit of provisional application Ser. No. 63/548,214, filed Nov. 12, 2023, and titled the same, and is hereby incorporated by reference as if fully restated herein.

### FIELD OF THE INVENTION

The present disclosure relates generally to computer-implemented system and, more specifically, to a computer-implemented system and method for secure and efficient digitization, validation, and disseminating professional credentials.

### BACKGROUND OF THE INVENTION

Current technology of computer systems does not allow the sharing of accurate, valid and updated professional credentials. Sharing of professional credentials is a fundamental aspect of networking and collaboration. Professionals regularly exchange credentials such as certifications, licenses, educational qualifications, and other pertinent information to establish trust and credibility. However, the existing methods of disseminating these credentials are often marred by administrative burdens and costs associated with ensuring that the shared credentials remain active and accurate.

One of the issues in the current state of technology is the lack of an automated and reliable system for verifying the validity of shared professional credentials. Professionals face challenges in keeping track of the expiration dates of their certifications or licenses and ensuring that the shared information is up-to-date. As a result, there is a heightened risk of professionals conveying, or others relying on, outdated, rescinded, or invalid credentials, potentially leading to misunderstandings, legal issues, or diminished professional trust.

Existing solutions for credential dissemination require manual verification processes, leading to significant administrative overhead for the institutions issuing the credentials, the individuals sharing credentials, and the entities receiving them. Additionally, the absence of a standardized and automated system for credential validation contributes to inefficiencies, delays, and increased costs in professional networks.

There remains a clear need for a computer system that can revolutionize the process of digitizing and disseminating valid professional credentials and alleviating the administrative burden and associated costs.

Ideally, it would be extremely useful to have a system and method for verifying and sharing professional credentials in a seamless and secure manner. Accordingly, there is need for a solution to at least one of the aforementioned problems.

### SUMMARY OF THE DISCLOSURE

Objects, features, and advantages of the present disclosure will become more readily apparent from the attached drawings and the detailed description of the preferred embodiments, which follow.

This disclosure is directed to a secure, computer-implemented method and system for automating the validation, management, and dissemination of professional credentials. Unlike conventional systems that rely on manual verification, this system introduces a validation engine leveraging blockchain technology and machine learning algorithms to ensure the integrity and real-time accuracy of credentials. The system also incorporates a notification module that proactively alerts credential holders of impending expirations, thus mitigating the risks associated with outdated or invalid credentials. This technological advancement addresses inefficiencies in existing credential management systems by improving data integrity, reducing latency, and enhancing user trust.

Those skilled in the art will further appreciate the above-mentioned advantages and superior features of the disclosure together with other important aspects thereof up reading the detailed description which follows in conjunction with the drawings

### BRIEF DESCRIPTION OF THE DRAWINGS

The preferred embodiments of the disclosure will hereinafter be described in conjunction with the appended drawings provided to illustrate and not to limit the invention, where like designations denote like elements, and in which:

FIG. 1A presents a logic flow chart in accordance with a at least one embodiment of the present disclosure; and

FIG. 1B presents a logic flow chart in accordance with a at least one embodiment of the present disclosure.

Like reference numerals refer to like parts throughout the several views of the drawings.

### DETAILED DESCRIPTION

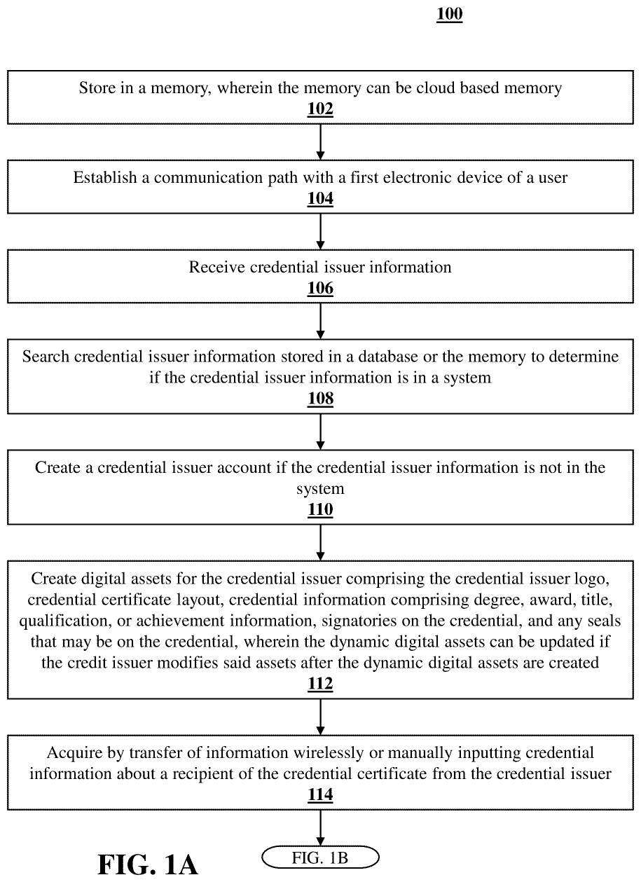

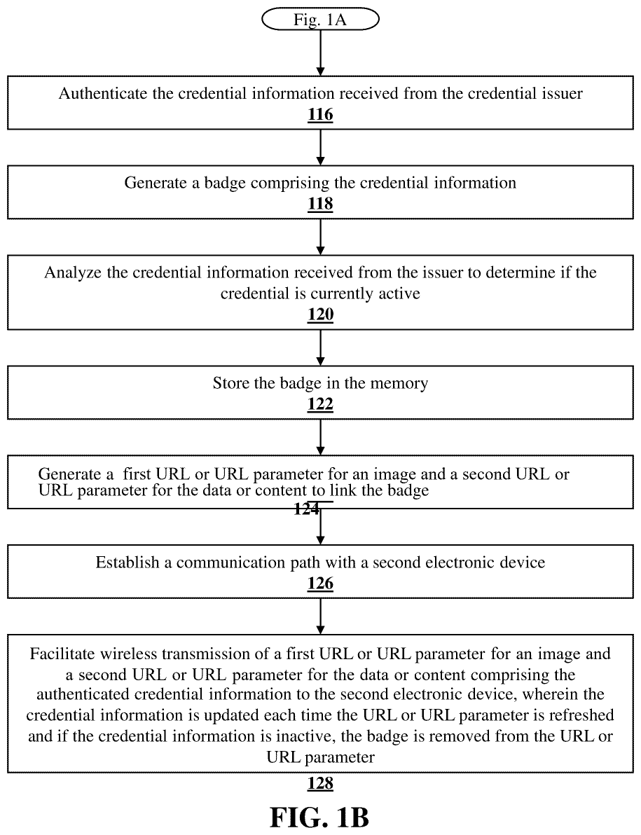

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a significant advancement in the field of computer systems, offering a solution to the persistent problems associated with the dissemination of professional credentials and ensuring those credentials are valid and accurate. The following sections of this patent application will provide a detailed description of the invention's components, functionality, and advantages, further establishing its novelty and utility in the realm of credential issuance by institution and management within professional networks.

A computer system designed to digitize, disseminate, and verify the validity of credentials may comprise certain components and functionalities. The computer system can comprise:

Credential Database (Optional): A centralized database to store and manage professional credentials securely may be provided by the present disclosure. Each credential entry should include relevant details such as certification type, expiration date, and any additional metadata.

Credential Issuer Profiles: profiles for credential issuers that allow them, or a user of the computer system, to input and manage the credentials they issue. Profiles may include institution information, contact details, credential details, logos, trademarks, information found on the certificates the institution typically issues such as signatories, what awards, degrees, certificates, etc., the institution issues, a history of credentials awarded to a specific professional, person, business, entity, etc. The credential issuer may modify its profile to update the credential information.

Automated Verification Mechanism: An automated mechanism to verify the validity of credentials in real-time.

Integration with external databases or certification authorities to cross-check the current status of certifications or licenses.

Expiration Alerts (optional): a notification system to alert professionals and relevant parties when credentials are approaching expiration. Alerts may be customizable based on user preferences and organizational requirements.

Blockchain Technology (Optional): Utilizing blockchain for secure and tamper-proof storage of credentials. Blockchain can enhance the integrity and immutability of the credential verification process.

Access Controls (Optional): Granular access controls may be provided determine who can view and verify specific credentials. Different levels of access may be provided for institutions, professionals, employers, clients, and other relevant stakeholders.

Encrypted Communication (Optional): Secure channels may be provided for the transmission of credential information between institutions, users, professionals and others. Encryption protocols may be employed to protect the confidentiality and integrity of data during transit.

User Authentication: User authentication mechanisms may be employed to ensure that only authorized entities or individuals can access and modify credential information. Multi-factor authentication may be employed for enhanced security.

Audit Trail (Optional): An audit trail or log system may be provided to track changes made to credential information and the history of verification requests. The Audit Trail may be used to compliance, accountability, and dispute resolution.

Compliance with Standards: Adherence to industry standards and regulations related to credential management and verification may be provided by the computer system along with compliance with data protection laws and privacy regulations.

User-Friendly Interface: Intuitive and user-friendly interfaces for institutions or optionally professionals managing their credentials. Mobile and web compatibility may be provided for ease of access.

Scalability: The ability to scale the computer system to accommodate a growing number of users and an increasing volume of credentials may be provided.

Integration Capabilities: Compatibility with existing systems and the ability to integrate with third-party platforms, such as HR systems or professional networking sites may be provided by the computer system.

Credential Input Interface: The system may comprise a user-friendly interface for institutions or users to input credential information into the system. This interface should include fields for various types of credentials, such as certifications, licenses, educational qualifications, etc.

Integration with External Databases: Integration with external databases or certification authorities or institutions relevant to each type of credential may be provided for by the system. Further, the system can establish API connections or other means to pull real-time data from authoritative sources to verify the current status of the credentials.

Regular Data Synchronization: Implement a scheduled or event-triggered data synchronization process to ensure that the system has the most up-to-date information from external databases may be provided for by the system. The system may regularly update the status of credentials in the system based on the information obtained from authoritative sources and/or when a URL or URL parameter is refreshed when the URL or URL parameter is activated or clicked on, the system will check the validity of the credential and if the credential is expired or no longer active, the URL or URL parameter will not display the credential.

Real-Time Verification Algorithm (Optional): The system may provide a verification algorithm that can process incoming verification requests in real-time. The algorithm may enable the system to check the current status, expiration date, and any other relevant criteria for each credential against the data obtained from external databases or data that may be stored in a database of a system.

Response Handling: A response handling mechanisms for different verification outcomes, such as valid, expired, rescinded, or invalid credentials may be provided for by the system. The response handling mechanism may be designed to receive and interpret responses from various sources, such as user inputs, network requests, or data feeds, and then output certain messages or credentials based on the information contained in the response. The message or credential can be displayed by the computer system through a URL or URL parameter.

Alerts and Notifications (Optional): The computer system may provide for an alert system to notify credential issuers, or credential receivers such as professionals when credentials are approaching expiration or have become invalid. Notifications may be configured to be generated and sent to relevant parties (e.g., employers, clients) when the URL and URL parameter is activated and refreshed for the credential and the credential is invalid.

Fallback Mechanisms (Optional): The system may provide for fallback mechanisms in case of connectivity issues or unavailability of external databases. The computer system may comprise a process or method to handle verification requests when real-time verification is temporarily not possible.

Machine Learning for Anomaly Detection (Optional): The computer system may employ and/or provide for machine learning algorithms to detect anomalies or patterns indicative of fraudulent or suspicious credential activity.

A credential issuer can be an education institution, a business organization that issues certifications or awards, or any entity or person that issues certifications, awards, degrees, licenses, or other documentation that a professional may receive to authenticate the professional is a professional.

The URL or URL parameter can be transmitted, embedded, or otherwise connected to a digital tap card such as a near-field communication (NFC) card or through a QR code or as a link embedded directly in an email, website, social media platform, digital resume, or the like. The dissemination of valid credentials is performed by the computer system through the URL or URL parameter in real time.

The credential issuer can provide its assets to the computer system by providing asset information, such as trademarks, logos, certificate or award information, credential issuer information such as name of award issuer, address, digital certificate design items such as award or certificate language, pictures, logos, signatories, a to adding digital certificates, awards and badges to their users. The system comprises means for inputting data, and the data may be inputted by one or a combination of means, such as a keyboard, audio device, video device, data drives, MIDI devices, or specialized hardware like laboratory measurement devices, special input hardware that allows a person with disabilities to input data such as gestural hardware that translates three-dimensional movement of the hands or body into character movement. The system can comprise a means for acquiring artwork and other assets of the credential issuer, and the acquired artwork or data may be acquired or transmitted through means of a network, uploading via web browsers, FTP clients, terminals (SCP/SFTP, a central server, peer-to-peer file sharing protocols, or other means. This disclosure is not intended to be limited to a specific means for acquiring artwork, assets, data, or other information that is inputted into the computer system.

The system can create a credential issuer profile or a company admin profile for the credential issuer.

The system can analyze information stored in memory for the system and if the credential issuer is new in the system, the system can employe means for creating a badge for the credential issuer.

The system may comprise a process to overlay variable text (credential recipient information, such as name, dates, specialty, validity dates) that can be viewed on any size device without shifting text. The system comprises a means for adding credential recipient and credential recipient information to each badge generated for a credential issuer. The system can also comprise a means for adding credential recipient information to a banner for an email or website for a credential user. This may be performed by inputting information into the system by uploading a spreadsheet, manually entering the information, automated integration with customer CRM/database, or a combination thereof. This disclosure is not intended to be limited by the means for entering information into the system.

The system may use an email address as a unique ID for the credential issuer or the credential recipient (also called a user) and the system. The system may verify if the user exists by performing a search of a databased located inside the system or external to the system for the email address. If the email address is not found, a user profile may be created. If the email address is found, the system can update information about the user that is different that the information previously acquired from the user.

The system comprises a means for generating a unique URL or URL parameter(s) for each user and each badge and/or banner to dynamically showcase the most updated information. Each time the URL or URL parameter is employed (e.g., clicked on), the information contained in the badge and/or banner is updated in real time. If new information is found when the URL or URL parameter is employed, the credential recipient can be notified that the badge and/or banner has been updated and the notification can comprise the new badge and/or banner with URL or URL parameter and process instructions.

If the credential issuer has changed its information, such as its logo or artwork, the system can generate an updated image for the existing URL or URL parameter with the updated logo or artwork. When the URL is refreshed, all new information can be displayed.

If expiry date of credential passes or the credential is otherwise invalid or invalidated, the badge and/or banner can be removed from the URL or URL parameter upon refresh of URL or URL parameter, and no badge and/or banner will be displayed for the expired or invalid credential. The credential issuer can update that status or expiry date of the credential, to a future date to immediately be able to see again. No change in URL

### User UX

The URL or URL parameter may be inputted into a variety dissemination objects, such as linking to an email, social media profile, an NFC product that can be tapped onto to any NFC capable device, or into a QR code. If a near-field communication card, e.g., NFC card, is employed, it can be tapped onto to any NFC capable device to transfer the badge and/or banner comprising the credential information or display the badge and/or banner image and other information associated with the badge and/or banner for the credential. A URL or URL parameter can be generated for each credential a credential recipient, such as a professional, receives from a variety of credential issuers, such as universities, government agents, regulatory agencies for the professional, and more. Transferring or transmitting the URL or URL parameter comprising the badge and/or banner to an NFC card may be performed by a manual process, an API call, or a combination thereof.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Turning to FIG. 1A, the computer-implemented system 100 can store in a memory (step 102), wherein the memory can be a cloud based memory, information and data, such as credential data, dynamic digital assets, authenticated credential information, user profiles, badge and/or banner data, and optionally audit trails and logs. The information and data stored in memory (step 102) can comprise degree information, awards, titles, qualifications, or achievements, along with metadata that may indicate the validity and expiration status of the credentials. Additionally, it may store dynamic digital assets, such as credential issuer logos, certificate layouts, signatory details, and seals, which can be updated if the credential issuer modifies them after creation. Authenticated credential information, verified and deemed active, may also be stored as part of badges and/or banners created for recipients. These badges and/or banners can comprise authenticated credential information and be linked to a unique URL or parameter. Optionally, the system may store audit trails and logs to capture changes to credential data and maintain a history of verification requests for compliance and accountability purposes.

The system 100 can establish a communication path with a first electronic device of a user (step 104). This communication path may be implemented using secure wireless transmission methods, including links embedded in emails, social media platforms, QR codes, or NFC (Near Field Communication) cards, through FTP sites, or using block chan. The system may utilize these mechanisms to transfer and update credential information dynamically, ensuring real-time accuracy and secure communication between devices. Also, the system 100 may comprise a sign-in feature through the established communication path with a first electronic device of a user (step 104) that enables the user to input data and information into the system 100.

The system 100 can receive credential issuer information (step 106) through multiple mechanisms. Credential issuer information may be manually entered into the system by authorized users via an intuitive interface that supports input fields for certifications, licenses, educational qualifications, logos, and other relevant metadata. The system 100 may facilitate the bulk integration of data through file uploads, such as spreadsheets, allowing credential issuers to provide large datasets efficiently. The system 100 may utilize application programming interfaces (APIs) to establish real-time connections with external databases or certification authorities, enabling the synchronization and verification of credential data as it is received. Data transfer may occur over secure network communication channels using encryption protocols to maintain confidentiality and data integrity. The system 100 may comprise a server infrastructure for hosting the credential database and managing API calls, user input devices such as keyboards or touchscreens for manual data entry, and network interface cards (NICs) to facilitate secure data communication. The system 100 may comprise high-capacity storage devices, such as solid-state drives (SSDs) or hard disk drives (HDDs), which may be employed to store credential information and metadata securely. For handling real-time data exchanges, the system 100 may also incorporate an API gateway hardware configuration.

The system may further operate by using API endpoints to retrieve credential issuer information from external systems. These endpoints can provide structured data formats, such as JSON or XML, which the system parses and integrates into its database. Alternatively, credential issuers may transfer data via file uploads through a designated portal, which the system processes to extract and store the relevant information. For manual operations, authorized users can input credential issuer data directly into the system through a secure web-based interface designed to ensure data accuracy and operational security.

The system 100 may search credential issuer information stored in a database or memory if the credential user information is in the system (step 108) by employing a processor configured to execute queries that compare inputted or retrieved credential issuer details, such as names, logos, or metadata, with existing entries in the system. This process can determine whether the credential issuer information already resides within the database or memory. If the information is not found, the system may initiate processes to create a new credential issuer account or profile. The system 100 may comprise a processor to execute search algorithms and compare credential data, along with high-capacity storage devices such as solid-state drives (SSDs) or hard disk drives (HDDs) for securely storing the credential issuer database. The system 100 may comprise a database server may host the relational or non-relational database, enabling efficient management of credential issuer information. Input and output interfaces, such as keyboards, APIs, or network interfaces, may facilitate the receipt of query inputs from users or external systems. Network interface cards (NICs) can enable communication between the system and external databases or systems when performing verification or synchronization tasks. Additionally, encryption modules may ensure the secure storage and retrieval of sensitive credential issuer information.

The system 100 may utilize structured query languages (SQL) or custom search algorithms within its memory management framework to efficiently perform these searches, ensuring that credential issuer information is accurately identified and appropriately managed within the system.

The system 100 can be implemented to create a credential issuer account when credential issuer information is not found (step 108) in the system 100 through an automated or user-assisted process. Upon determining that the credential issuer information is absent, the system may prompt the user or an authorized entity to provide additional details required to establish the account. This process may involve the input of metadata, such as the name of the credential issuer, contact information, certifications offered, logos, and other relevant attributes. The input may occur via a user-friendly interface, file uploads, or an API integration that facilitates seamless data transfer from external sources.

The system 100 may then validate the entered information for accuracy and completeness by cross-referencing it with external databases or using predefined validation rules. Once verified, the system can assign a unique identifier to the credential issuer account, ensuring traceability and eliminating redundancy. The account details may then be encrypted and stored securely in the system's database or memory, protected by high-capacity storage devices such as solid-state drives (SSDs) or hard disk drives (HDDs).

This implementation may rely on a processor to execute the account creation logic and manage database updates. A database server can be used to handle the storage and retrieval of credential issuer records, while network interface cards (NICs) may enable communication with external validation systems or users. Additional hardware, such as input and output interfaces, can facilitate the manual entry or transfer of data during the account creation process. Encryption modules may be employed to ensure the confidentiality of credential issuer information, securing it during transmission and storage.

The system 100 may create digital assets for the credential issuer (step 110). These digital assets can comprise the credential issuer's logo, credential certificate layout, credential information such as degree, award, title, qualification, or achievement details, signatories on the credential, and any seals that may appear on the credential. These dynamic digital assets can be updated if the credential issuer modifies the assets after their initial creation. To execute this step, the system 100 may rely on a processor for rendering and assembling the digital assets, and memory or storage devices to securely store these assets. A user interface, potentially comprising a graphical editor, may allow authorized users to design or modify the assets, while network interface hardware may facilitate integration with external systems to retrieve updated assets as necessary.

The system 100 can acquire credential information about a recipient of the credential certificate from the credential issuer, either wirelessly or through manual input (step 112). This information may be transferred via a secure API, uploaded as a file, or entered directly into the system through a user interface. The hardware necessary to perform this step may comprise input devices such as keyboards, touchscreens, or automated data import tools. Wireless transfers may be supported by network interface cards (NICs), enabling secure data receipt from the credential issuer's system.

The system 100 may authenticate the credential information received from the credential issuer (step 114). This process can comprise verifying the information against records stored in the system's database or through external validation with authoritative databases. The system 100 may use encryption modules to secure communication during the authentication process and apply machine learning algorithms or rule-based logic executed by a processor to identify anomalies or discrepancies in the credential information.

The system 100 can generate a badge and/or banner that comprises the recipient's authenticated credential information (step 116). This badge and/or banner may be created as a dynamic digital object reflecting details such as the recipient's name, achievement type, and issuer details. The hardware required for this step may comprise a processor to assemble the badge and/or banner and a display interface to preview the badge and/or banner before storage or dissemination. The badge and/or banner may also incorporate encryption to ensure its integrity during storage and transmission.

The system 100 may analyze the credential information received from the issuer to determine if the credential is currently active (step 118). This analysis can involve evaluating metadata fields such as expiration dates or revocation flags against entries in the system's database. A processor may execute the logic necessary for this analysis, while network hardware can facilitate real-time validation through connections to external databases.

The system 100 can store the badge and/or banner in memory, which may comprise cloud-based storage or a local database (step 120). The system may organize badges and/or banners in a secure and searchable format, with encryption modules ensuring the confidentiality of stored data. Storage hardware may include solid-state drives (SSDs) or hard disk drives (HDDs) optimized for high-speed access and reliability.

The system 100 may generate a URL or URL parameter that links directly to the badge and/or banner (step 122). This URL may serve as a unique digital identifier for accessing or sharing the badge and/or banner. The system 100 may generate a first URL or URL parameter to link an image and a second URL to link content or data the badge or banner. The generation process can rely on a processor for constructing the URL and a database for storing the mapping between the badge and/or banner and its associated URL. The system may also incorporate access control measures to ensure that only authorized users can retrieve or view the badge and/or banner via the URL.

The system 100 can establish a communication path with a second electronic device to enable the secure sharing of credential information (step 124). This communication path may use secure protocols such as SSL/TLS to ensure data confidentiality during transmission. Necessary hardware for this step may comprise network interface cards (NICs) and routers capable of supporting encrypted and reliable communication channels.

The system 100 may facilitate the wireless transmission of the first URL or URL parameter to link an image and the second URL to link content or data the badge and/or banner to the second electronic device (step 126). The URL may dynamically reflect authenticated credential information, updating automatically each time it is refreshed. If the credential information becomes inactive, the system may remove the badge and/or banner from the associated URL or parameter. Wireless communication modules, such as Wi-Fi or Bluetooth interfaces, may support the transmission process.

The system 100 can refresh the badge and/or banner with updated credential information to ensure the first URL or URL parameter to link an image and the second URL to link content or data always reflects the current status of the credentials (step 128). If the credential becomes inactive, the system may deactivate the badge and/or banner and unlink it from the URL or parameter. The system 100 can generate a first URL or URL parameter for a badge and/or a banner and a second URL or URL parameter for the badge and/or banner. This functionality may rely on a processor to monitor changes in credential status and dynamically update the badge and/or banner. Network interfaces may facilitate real-time updates from external systems or the credential issuer, ensuring the badge and/or banner remains accurate and secure. The badge and/or banner can be placed in an email signature, website, social media pages, or loaded onto a tap card. The system 100 can generate a dynamic image for the credential user to attach, embed, place, or the like the dynamic image in an email signature, website, social media page, tap card, or generate the HTML code for the credential user to generate the dynamic image for the badge and/or banner.

Since many modifications, variations, and changes in detail can be made to the described preferred embodiments of the invention, it is intended that all matters in the foregoing description and shown in the accompanying drawings be interpreted as illustrative and not in a limiting sense.

Although some, and maybe preferred, embodiments of the disclosure have been described in detail herein, those skilled in the art will recognize that various substitutions and modifications may be made without departing from the scope and spirit of the appended claims. Thus, the scope of the invention should be determined by the appended claims and their legal equivalents.

What is claimed is:

1. A computer-implemented system for digitizing, validating, and disseminating credentials comprising:
a memory, wherein the memory can be cloud based memory; and
a processor coupled to the memory, the processor being configured to:
establish a communication path with a first electronic device of a user;
receive credential issuer information;
search credential issuer information housed in a database or in the memory to determine if the credential issuer information is in the system;
create a credential issuer account if the credential issuer information is not in the system; create dynamic digital assets for the credential issuer comprising the credential issuer logo, credential certificate layout, credential information comprising degree, award, title, qualification, or achievement information, signatories on the credential, and any seals that may be on the credential, wherein the dynamic digital assets can be updated if the credit issuer modifies said assets after the dynamic digital assets are created;
acquire credential information about a recipient of the credential certificate from the credential issuer;
authenticate the credential information received from the credential issuer;
generate a badge or banner comprising the credential information;
analyze the credential information received from the issuer to determine if the credential is currently active;
store badge comprising the authenticated credential information in the memory;
generate a first URL or URL parameter to link an image and a second URL to link content or data the badge comprising the stored authenticated credential information, wherein;
establish a communication path with a second electronic device; and
facilitate wireless transmission of first URL or URL parameter for an image and a second URL or URL parameter for the data or content comprising the authenticated credential information to the second electronic device, wherein the credential information is updated on the badge each time first or second the URL or URL parameter is refreshed and if the credential information is inactive, invalid, or expired, the badge is removed from the URL or URL parameter.

2. The system of claim 1, wherein the second electronic device is a near-field communication card.

3. The system of claim 1, wherein the second electronic device is a mobile device.

4. The system of claim 1, wherein the second electronic device is a laptop or desktop computer.

5. The system of claim 1, wherein the communication path is a QR code.

6. The system of claim 1, wherein the communication path is a URL linked to an email, social media page, or website.

7. A method for digitizing, validating, and disseminating credentials comprising:
storing in a memory, wherein the memory can be cloud based memory;
establishing a communication path with a first electronic device of a user;
receiving credential issuer information;
searching credential issuer information stored in a database or the memory to determine if the credential issuer information is in a system;
creating a credential issuer account if the credential issuer information is not in the system;
creating digital assets for the credential issuer comprising the credential issuer logo, credential certificate layout, credential information comprising degree, award, title, qualification, or achievement information, signatories on the credential, and any seals that may be on the credential, wherein the dynamic digital assets can be updated if the credit issuer modifies said assets after the dynamic digital assets are created;
acquiring by transfer of information wirelessly or manually inputting credential information about a recipient of the credential certificate from the credential issuer;
authenticating the credential information received from the credential issuer;
generating a badge comprising the credential information;
analyzing the credential information received from the issuer to determine if the credential is currently active;
storing the badge in the memory;
generating first URL or URL parameter for an image and a second URL or URL parameter for the data or content to link the badge or banner;
establishing a communication path with a second electronic device; and
facilitating wireless transmission of the badge or banner comprising the authenticated credential information to the second electronic device, wherein the credential information is updated each time the first or second URL or URL parameter is refreshed and if the credential information is inactive, the badge or banner is removed from the URL or URL parameter.

8. The system of claim 1, wherein the second electronic device can be a near-field communication card.

9. The system of claim 1, wherein the second electronic device is a mobile device.

10. The system of claim 1, wherein the second electronic device is a laptop or desktop computer.

11. The system of claim 1, wherein the communication path is a QR code.

12. The system of claim 1, wherein the communication path is a URL linked to an email, social media page, or website.

13. A computer-implemented system for securely managing and disseminating professional credentials, the system comprising:
a credential database configured to store credential data, including metadata indicating validity and expiration;
a credential validation engine configured to:
access real-time data from trusted third-party systems via an application programming interface (API);
verify the authenticity and current status of credentials using cryptographic hashing and blockchain integration;
a dissemination module configured to:
share validated credential data through encrypted communication channels;
restrict dissemination to active credentials verified by the credential validation engine;
a notification module configured to:
monitor credential expiration dates;
automatically generate and transmit expiration alerts to credential holders.
